(19) United States
(12) Patent Application Publication
(10) Pub. No.: US 2026/0287135 A1
(43) Pub. Date: Sep. 24, 2026

(54) INTEGRATED LAMP CONTROL MODULES

(71) Applicant: Autosystems, a division of Magna Exteriors Inc., Aurora (CA)

(72) Inventor: Peter SERCL, Newmarket (CA)

(21) Appl. No.: 19/566,081

(22) Filed: Mar. 13, 2026

Related U.S. Application Data
(60) Provisional application No. 63/774,160, filed on Mar. 19, 2025.
(60) Provisional application No. 63/796,874, filed on Apr. 29, 2025.

(51) Int. Cl. F21S 41/19; F21S 41/141; F21S 45/33; F21S 45/43; F21S 45/48; F21W 102/13

(52) U.S. Cl. CPC F21S 41/192; F21S 41/141; F21S 45/33; F21S 45/43; F21S 45/48; F21W 2102/13

(57) ABSTRACT

A lighting control module for a vehicle includes: a housing, an internal connector, and an external connector. The housing defines a back surface that is configured to lie flat against an outer surface of an enclosure of a lighting assembly for coupling the lighting control module to the lighting assembly. The internal connector is coupled to the back surface and configured to deliver power to one or more light sources inside the enclosure of the lighting assembly. The external connector is configured to attach to an external power source outside of the enclosure of the lighting assembly. The lighting control module is configured to supply power to the one or more light sources inside the enclosure of the lighting assembly using electrical current from the external power source.

### CROSS REFERENCE TO RELATED APPLICATIONS

This utility patent application claims the benefit of U.S. Provisional Patent Application No. 63/774,160 filed Mar. 19, 2025, and U.S. Provisional Patent Application No. 63/796,874 filed Apr. 29, 2025, the contents of which are incorporated herein by reference in their entirety.

### FIELD

The present disclosure relates generally to lighting for motor vehicles. More specifically, the present disclosure relates to designs for integrated lamp control modules for lighting assemblies, such as headlights, for passenger vehicles, such as cars and trucks.

### BACKGROUND

Lighting assemblies, such as headlight assemblies, for vehicles commonly include one or more lighting control modules. One common type of lighting control module is an LED driver module (LDM). Some high-end headlights may include as many as three LDMs. Each LDM typically has its own internal harness connector and weather seal. The headlamp housing may also use a wire harness pass-through to supply power through to internal components and to the LDMs.

Conventional lighting assembly housings have several additional components, such as access panels and vents. Each of these components and features adds costs and complexity to the lighting assembly.

### SUMMARY

The present disclosure provides a lighting control module for a vehicle. The lighting control module includes: a housing, an internal connector, and an external connector. The housing defines a back surface that is configured to lie flat against an outer surface of an enclosure of a lighting assembly for coupling the lighting control module to the lighting assembly. The internal connector is coupled to the back surface and configured to deliver power to one or more light sources inside the enclosure of the lighting assembly. The external connector is configured to attach to an external power source outside of the enclosure of the lighting assembly. The lighting control module is configured to supply power to the one or more light sources inside the enclosure of the lighting assembly using electrical current from the external power source.

The present disclosure also provides a lighting assembly for a vehicle. The lighting assembly includes: an enclosure; one or more light sources disposed inside the enclosure; and a lighting control module disposed on an outside surface of the enclosure. The lighting control module includes: an internal connector configured to deliver power to one or more light sources inside the enclosure, and an external connector configured to attach to an external power source outside of the enclosure of the lighting assembly.

The present disclosure also provides a vehicle. The vehicle includes: a lighting assembly. The lighting assembly includes: an enclosure; one or more light sources disposed inside the enclosure; and a lighting control module disposed on an outside surface of the enclosure. The lighting control module includes: an internal connector configured to deliver power to one or more light sources inside the enclosure, and an external connector configured to attach to an external power source outside of the enclosure of the lighting assembly.

These and other aspects of the present disclosure are disclosed in the following detailed description of the embodiments, the appended claims, and the accompanying figures.

### BRIEF DESCRIPTION OF THE DRAWINGS

Further details, features and advantages of designs of the invention result from the following description of embodiment examples in reference to the associated drawings.

FIG. 1 shows a schematic block diagram of a vehicle with two headlight assemblies.

FIG. 2 shows a perspective view of a first lighting assembly for a vehicle.

FIG. 3 shows a perspective view of an LED driver module (LDM) for the first lighting assembly of FIG. 2.

FIG. 4 shows a schematic block diagram of components in a highly integrated LDM (HI-LDM), in accordance with an aspect of the present disclosure.

FIG. 5A shows a side view of a first lighting control module, in accordance with an aspect of the present disclosure.

FIG. 5B shows an interior view of a housing of the first lighting control module of FIG. 5A.

FIG. 5C shows an outside front view of the first lighting control module of FIG. 5A.

FIG. 5D shows a view of the first lighting control module of FIG. 5A from inside of a headlamp assembly to which the first lighting control module of FIG. 5A is attached.

FIG. 6A-6B each show side views of a second lighting control module, in accordance with an aspect of the present disclosure.

FIG. 7A-7B each show corresponding views of a second lighting assembly with the second lighting control module of FIGS. 6A-6B attached thereto.

FIG. 8A-8B each show side views of a third lighting control module, in accordance with an aspect of the present disclosure.

FIG. 9A-9B each show corresponding views of a third lighting assembly with the third lighting control module of FIGS. 8A-8B attached thereto.

FIG. 10 shows a cutaway side view of a lighting assembly including a lighting control module, in accordance with an aspect of the present disclosure.

### DETAILED DESCRIPTION

Referring to the drawings, the present invention will be described in detail in view of following embodiments.

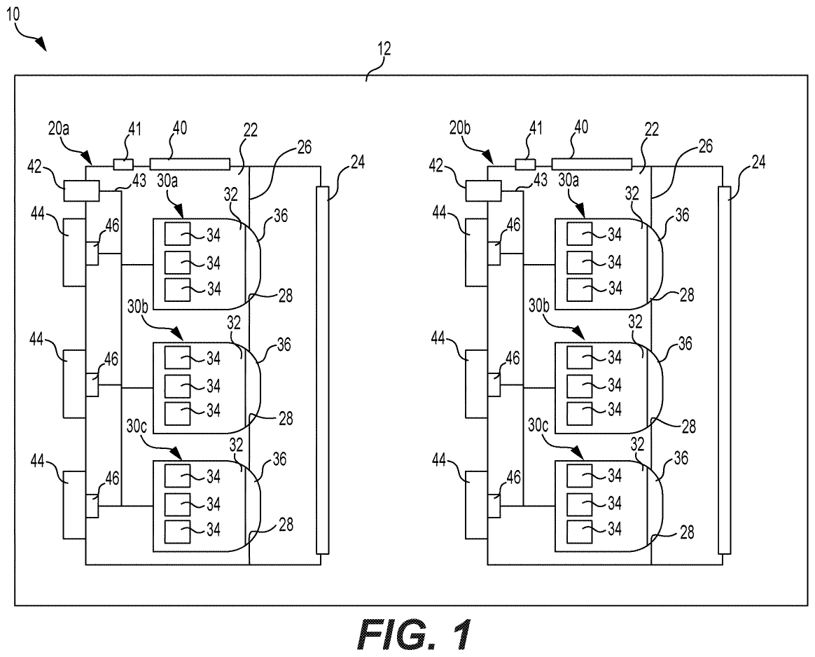

FIG. 1 shows a schematic block diagram of a vehicle 10 with a lighting system 12, according to an aspect of the present disclosure. The vehicle 10 may be a motor vehicle, such as a passenger car or truck. However, the lighting systems of the present disclosure may be applicable to other types of vehicles, such as commercial trucks, busses, trains, etc. The vehicle 10 with the lighting system 12 of the present disclosure may also be referred to as the ego vehicle or the subject vehicle. The lighting system 12 includes a left-side headlight assembly 20a and a right-side headlight assembly 20b. Each of the headlight assemblies 20a, 20b may be similar or identical to one-another. In some embodiments, the headlight assemblies 20a, 20b may include similar or identical internal components and different external components, such as a first enclosure 22 that is configured to fit within the structure on the corresponding side of the vehicle 10.

As shown in FIG. 1, each of the headlight assemblies 20a, 20b also includes a first outer lens 24 of transparent material for emitting light and a bezel 26 disposed within a corresponding one of the first enclosures 22. Each of the bezels 26 defines a plurality of openings 28. Each of the each of the headlight assemblies 20a, 20b also includes three lighting modules 30a, 30b, 30c. However, the headlight assemblies 20a, 20b may include a different number of the lighting modules 30a, 30b, 30c. The lighting modules 30a, 30b, 30c may provide high-beam (HB) and low-beam (LB) illumination and/or other vehicle lighting functionality, such as turn signal indicator, daytime running light, fog light function, etc.

In some embodiments, and as shown in FIG. 1, each of the lighting modules 30a, 30b, 30c includes a plurality of light sources 34. FIG. 1 shows three of the light sources 34 in each of the each of the lighting modules 30a, 30b, 30c. However, this is merely for simplicity of illustration. The lighting modules 30a, 30b, 30c may include any number of the light sources 34. Each of the light sources 34 may include one or more light emitting diodes (LEDs) disposed on a substrate, such as a printed circuit board. However, the light sources 34 may include other types of illumination sources, such as LED arrays, organic LEDs (OLEDs) halogen bulbs, high-intensity discharge (HID) lamps, lasers, etc.

Each of the lighting modules 30a, 30b, 30c also includes a first secondary lens 36, for focusing and directing light emitted by the corresponding light sources 34. The first secondary lens 36 may be made of polycarbonate (PC) or Poly(methyl methacrylate) (PMMA). However, the first secondary lens 36 may include one or more other materials. In some embodiments, and as shown in FIG. 1, the first secondary lenses 36 may each protrude through a corresponding one of the openings 28 in the bezels 26. Each of the two dual-projector lighting modules 30a, 30b also includes a first lamp housing 32. The first lamp housings 32 may be made of a high-temperature polycarbonate (PC-HT) material or a standard temperature (not high-temperature) polycarbonate (PC) material. However, the first lamp housings 32 may include one or more other materials. The first lamp housings 32 each hold the corresponding light sources 34 and a corresponding one of the first secondary lenses 36, with the corresponding first secondary lens 36 at a fixed position relative to the light sources 34 and spaced apart therefrom.

The first enclosures 22 of each of the headlight assemblies 20a, 20b each include an access port 40 for installing and/or servicing internal components, such as the lighting modules 30a, 30b, 30c. Each of the first enclosures 22 also includes a vent 41 for allowing air to pass to an interior thereof. The vents 41 may include a membrane that allows air to pass therethrough while preventing liquid water or other contaminants from entering into the interior of the first enclosures 22. Each of the first enclosures 22 also includes a wire harness pass-through 42 for a wiring harness 43 to enter to supply power and/or control signals to each of the lighting modules 30a, 30b, 30c.

As shown, each of the headlight assemblies 20a, 20b also includes three LED driver modules (LDMs) 44 attached to the corresponding one of the first enclosures 22. The three LDMs 44 is configured to supply power to a corresponding one of the lighting modules 30a, 30b, 30c. Each of the three LDMs 44 includes an internal connector 46 that releasably connects to the wiring harness 43 inside the first enclosure 22 of the corresponding one of the the headlight assemblies 20a, 20b.

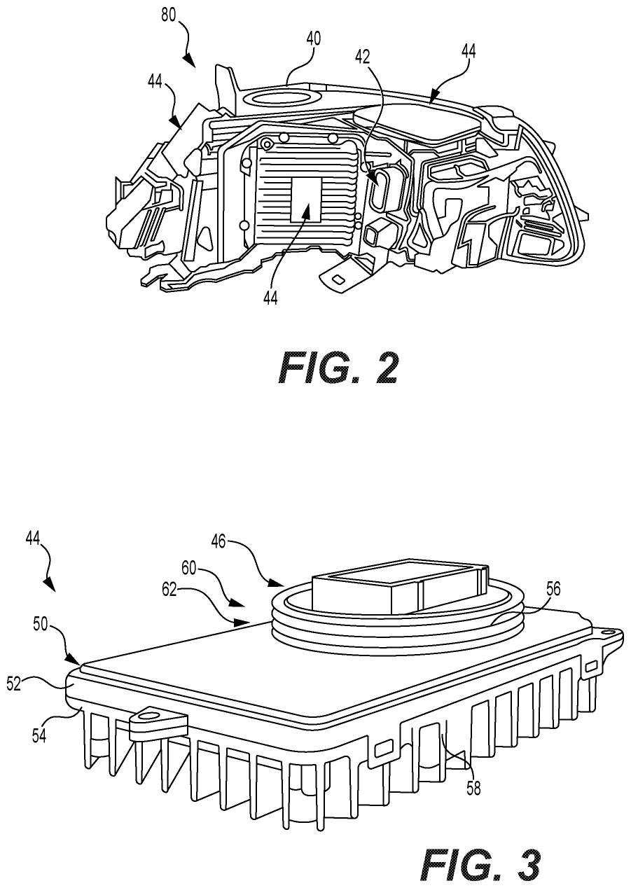

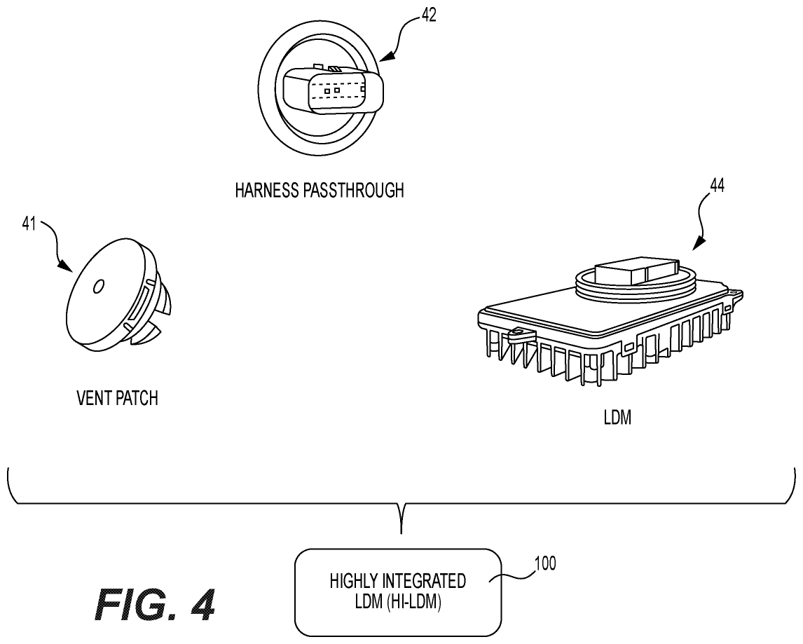

FIG. 2 shows a perspective view of a first lighting assembly 80 that may be used for each of the headlight assemblies 20a, 20b of FIG. 1. FIG. 3 shows a perspective view of an LED driver module (LDM) 44 for the first lighting assembly 80 of FIG. 2. The LDM 44 may have a conventional arrangement including a housing 50 having a baseplate 52 and a cover 54 attached together in a clamshell arrangement. The baseplate 52 may be made of plastic or other molded material and defines a back surface 56 that is configured to lie flat against an outer surface of the first enclosure 22 of the corresponding one of the the headlight assemblies 20a, 20b. The cover 54 may be made of Aluminum or other metal and defines fins 58 for radiating heat to cool power electronics devices inside of the housing 50.

The housing 50 also includes a protruding portion 60 that extends outward from the back surface 56 and which is configured to extend into an interior of the of the first enclosure 22 of the corresponding one of the headlight assemblies 20a, 20b. A weather seal 62 extends around a peripheral edge of the protruding portion 60, and the internal connector 46 is disposed on an end of the protruding portion 60, opposite from the back surface 56 of the housing 50.

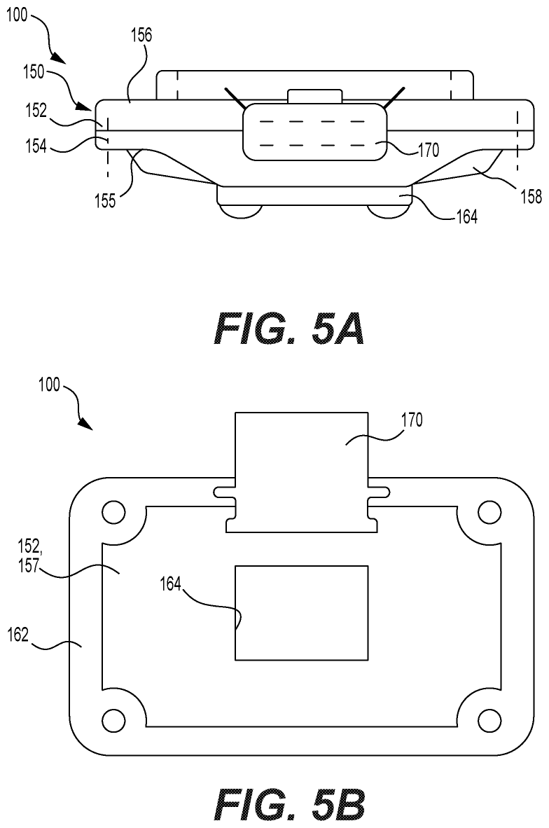

FIG. 4 shows a schematic block diagram of components in a first lighting control module 100, in accordance with an aspect of the present disclosure. The first lighting control module 100 may also be called a first highly-integrated LED driver module (HI-LDM). As shown, the first lighting control module 100 combines functions and components of an LDM 44, together with the vent 41, and the wire harness pass-through 42.

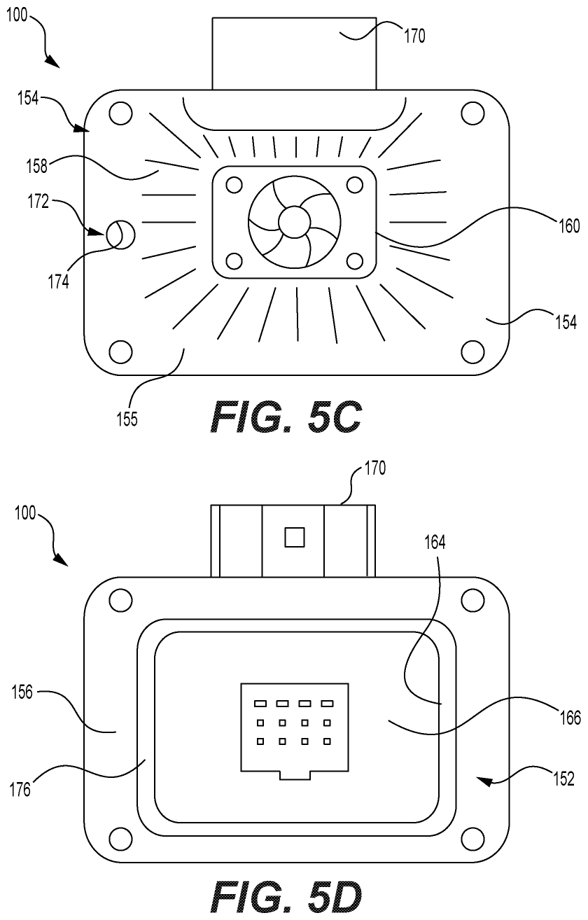

FIG. 5A-5D shows various views of the first lighting control module 100. The first lighting control module 100 includes a first LDM housing 150 having a baseplate 152 and a cover 154 attached together in a clamshell arrangement. The baseplate 152 may be made of plastic or other molded material and defines a first back surface 156 that is configured to lie flat against an outer surface of an enclosure of a lighting assembly, such one of the headlight assemblies 20a, 20b. The cover 154 may be made of Aluminum or other metal and defines an outside surface 155. The outside surface 155 of the cover 154 defines fins 158 for radiating heat to cool power electronics devices inside of the first LDM housing 150. A cooling fan 160 is attached to an outside surface of the cover 154 with a plurality of screws and is and arranged to blow air over the outside surface 155 and through the fins 158 for dissipating heat from the first LDM housing 150.

In some embodiments, and as shown in FIG. 5A-5D, the first lighting control module 100 would not be a sealed housing, but would seal to the enclosure of the lighting assembly, making the overall lamp the fully sealed product. Cast or stamped aluminum portions of the first LDM housing 150 then can also improve heat transfer from the internal volume of air within the headlight assembly 20a, 20b to the ambient environment. The first back surface 156 that is configured to lie flat against an outer surface of an enclosure of a lighting assembly, such as the first enclosure 22 one of the headlight assemblies 20a, 20b.

As shown in FIG. 5B, the baseplate 152 defines an internal flange 157 opposite of the first back surface 156. A first gasket 162, which may be made of room-temperature-vulcanizing silicone (RTV) silicone, is disposed around a periphery of the internal flange 157 for sealing against the cover 154. The internal flange 157 of the baseplate 152 also defines a cutout 164 for an internal connector 166 of the first lighting control module 100 to pass through and into an interior of the enclosure of the lighting assembly for delivering power to one or more light sources therein. The unsealed cutout 164 may provide fluid communication through the baseplate 152 and into an interior of the enclosure of the lighting assembly. The internal connector 166 may be configured as a receptacle, as shown on FIG. 5D to releasably attach to an internal wiring harness inside enclosure of the lighting assembly. However, the internal connector 166 may have another configuration such as a wiring harness or pigtail with wires that extend out of the first LDM housing 150.

As best shown on FIG. 5C, the first lighting control module 100 also includes a membrane 172 of air permeable material arranged to allow pressure equalization between an interior of the enclosure of the lighting assembly and an ambient atmosphere. The membrane 172 may be provided in the form of a snap-in patch of material sold under the trade name GORE, and which may be installed in a corresponding hole 174 in the cover 154 of the first LDM housing 150.

As best shown on FIG. 5D, a second gasket 176 is disposed on the first back surface 156 of the baseplate 152 for sealing the first LDM housing 150 against the outer surface of the enclosure of the lighting assembly. The second gasket 176 may be made of rubber or another resilient material and may be spaced apart from the peripheral edge of the baseplate 152 and to surround the cutout 164 and the internal connector 166.

As also shown in FIG. 5A-5B, the first lighting control module 100 also includes a first external connector 170 configured to attach to an external power source, such as a vehicle wiring harness. The first external connector 170 is disposed on a side of the first LDM housing 150 perpendicular to the first back surface 156. In some embodiments, and as shown in FIGS. 5A-5B, the first external connector 170 is includes a receptacle for releasable connection to an external wiring harness. However, the first external connector 170 may have another form, such as a wiring harness or pigtail with wires that extend out of the first LDM housing 150.

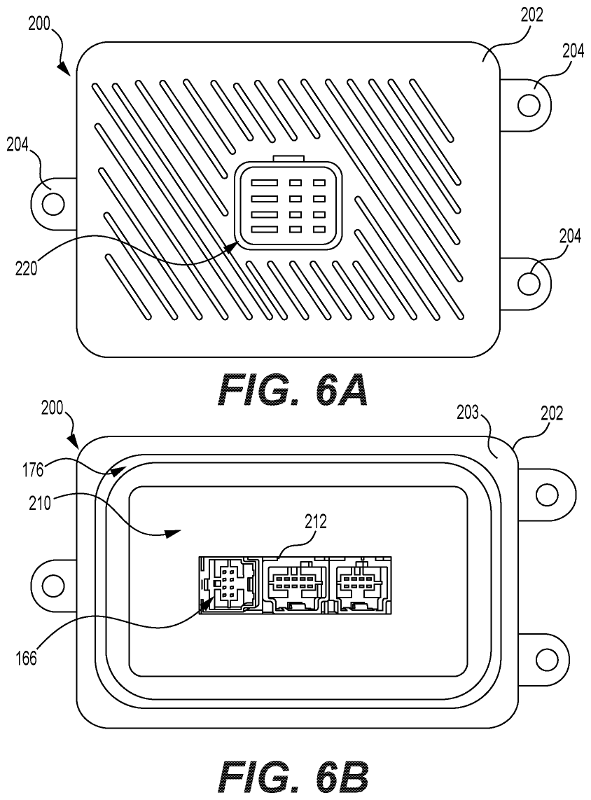

FIG. 6A-6B each show side views of a second lighting control module 200, in accordance with an aspect of the present disclosure. The second lighting control module 200 may also be called a second HI-LDM and may be similar or identical to the first lighting control module 100, except for differences described herein. The second lighting control module 200 includes a second LDM housing 202 that may be similar or identical to the first LDM housing 150, except for differences described herein. The second LDM housing 202 defines a second back surface 203 that may be similar or identical to the first back surface 156 of the first LDM housing 150. The second LDM housing 202 also defines three tabs 204 extending from sides thereof. The three tabs 204 each define a hole for receiving a screw or other fastener for securing the second lighting control module 200 to an outside surface of an enclosure of a lighting assembly. The second lighting control module 200 also includes three of the internal connectors 166 for connection to three different light sources 34 in the lighting assembly.

As also shown in FIG. 6A, the second lighting control module 200 includes a second external connector 220 that is disposed on a front side of the second LDM housing 202, opposite the second back surface 203. This second external connector 220 is provided instead of the first external connector 170 of the first lighting control module 100 and may have a similar or identical configuration, except for the difference in placement relative to the corresponding LDM housing 150, 202

As best shown in FIG. 6B, the second lighting control module 200 includes a printed circuit board (PCB) 210 disposed in the second LDM housing 202. The PCB 210 defines a passage 212, and the internal connectors 166 extend through the passage 212 in the PCB 210.

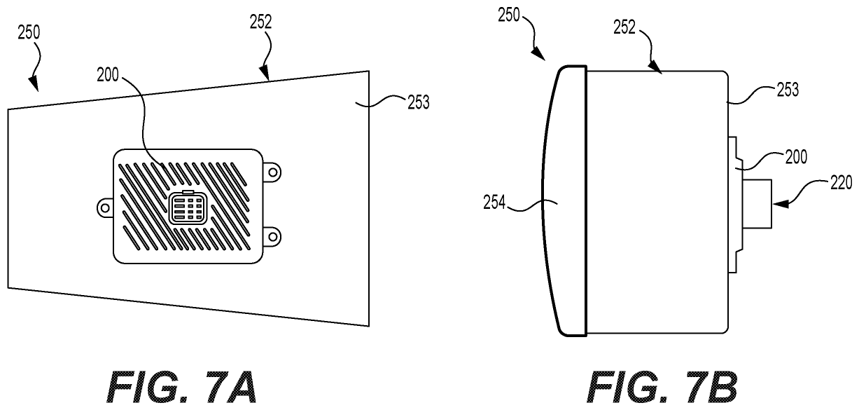

FIG. 7A-7B each show corresponding views of a second lighting assembly 250 with the second lighting control module 200 of FIGS. 6A-6B attached thereto. As shown, the second lighting assembly 250 includes a second enclosure 252 with a second outer lens 254. The second enclosure 252 and the second outer lens 254 may be similar or identical to the first enclosure 22 and the first outer lens 24 of the headlight assemblies 20a, 20b, respectively. As shown, the second lighting control module 200 is attached to and lies flat against a rear outer surface 253 of the second enclosure 252, opposite from the second outer lens 254.

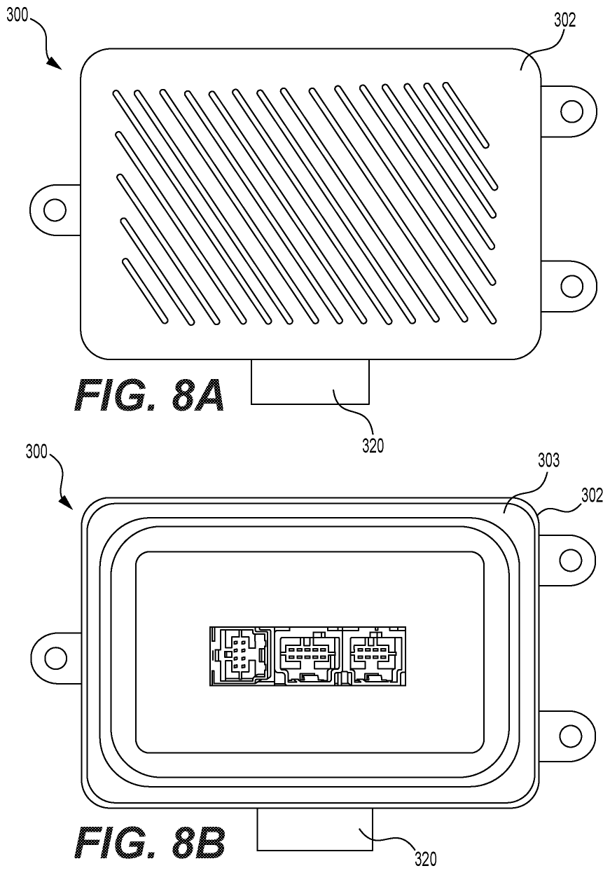

FIG. 8A-8B each show side views of a third lighting control module 300, in accordance with an aspect of the present disclosure. The third lighting control module 300 may also be called a third HI-LDM and may be similar or identical to the second lighting control module 200, except for differences described herein. The third lighting control module 300 includes a third LDM housing 302 that may be similar or identical to the second LDM housing 202, except with differences described herein. The third LDM housing 302 defines a third back surface 303 that may be similar or identical to the second back surface 203 of the second LDM housing 202. The third lighting control module 300 also includes third external connector 320 that is disposed on a side of the third LDM housing 302 perpendicular to the third back surface 303.

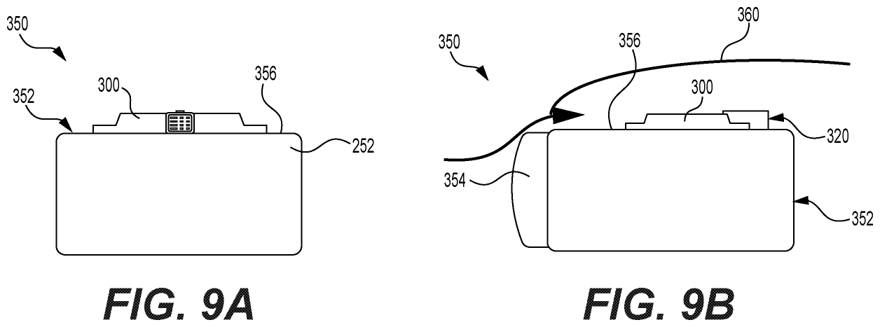

FIG. 9A-9B each show corresponding views of a third lighting assembly 350 with the third lighting control module 300 of FIGS. 8A-8B attached thereto. As shown, the third lighting assembly 350 includes a third enclosure 352 with a third outer lens 354. The third enclosure 352 and the third outer lens 354 may be similar or identical to the first enclosure 22 and the first outer lens 24 of the headlight assemblies 20a, 20b, respectively. As shown, the third lighting control module 300 is attached to and lies flat against a top outer surface 356 of the third enclosure 352, perpendicular to and above the third outer lens 354.

In some embodiments, and as shown in FIG. 9B, the third lighting assembly 350 may be installed in a vehicle with a hood 360 that is arranged to channel airflow under the hood 360 and across the third lighting control module 300 for cooling the third lighting control module 300 while the vehicle is in motion.

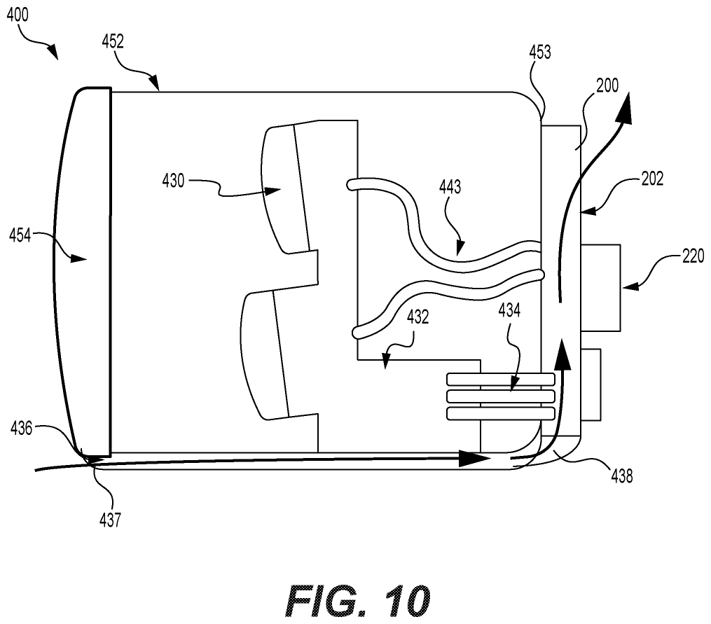

FIG. 10 shows a cutaway side view of a fourth lighting assembly 400 including a lighting control module, in accordance with an aspect of the present disclosure. As shown, the fourth lighting assembly 400 includes a fourth enclosure 452 with a fourth outer lens 454. The fourth enclosure 452 and the fourth outer lens 454 may be similar or identical to the first enclosure 22 and the first outer lens 24 of the headlight assemblies 20a, 20b, respectively. As shown, a second lighting control module 200 is attached to and lies flat against a rear outer surface 453 of the fourth enclosure 452, opposite from the fourth outer lens 454.

The fourth lighting assembly 400 also includes two light sources in the form of projector lamps 430 located inside the fourth enclosure 452, and which may be similar or identical to the lighting modules 30a, 30b, 30c of the headlight assemblies 20a, 20b. As shown, the fourth lighting assembly 400 also includes an internal cooling block 432 located inside the fourth enclosure 452, and configured to conduct heat from the projector lamps 430. The internal cooling block 432 is in thermal communication with the second lighting control module 200 attached thereto to remove the heat from the fourth enclosure 452.

In some embodiments, and as also shown in FIG. 10, the fourth lighting assembly 400 also includes one or more heat pipes 434 that are configured to conduct the heat from the internal cooling block 432 and to the second lighting control module 200 for removing the heat from the fourth enclosure 452.

In some embodiments, and as also shown in FIG. 10, the fourth enclosure 452 of the fourth lighting assembly 400 also defines an air duct 436, which may also be called an air intake duct, and which is configured to direct airflow over a heat spreader of the second lighting control module 200 attached thereto. The heat spreader of the second lighting control module 200 may include, for example, fins 158 cast into or otherwise formed on a cover thereof. The air duct 436 may be molded or otherwise integrally formed with the fourth enclosure 452. In some embodiments, and as shown on FIG. 10, the air duct 436 may extend between an intake 437 that is adjacent to the fourth outer lens 454 and to the second lighting control module 200 on the rear outer surface 453 of the fourth enclosure 452. In some embodiments, and as also shown on FIG. 10, the air duct 436 may include one or more baffles 438 or other features to spread and/or direct the air across various portions of the heat spreader of the second lighting control module 200 in order to improve conduction of heat away from the heat spreader of the second lighting control module 200 and into the air passing thereacross.

As shown on FIG. 10, the fourth lighting assembly 400 also includes an internal wiring harness 443 configured to conduct electrical current between the second lighting control module 200 and the projector lamps 430 in the fourth enclosure 452. In some embodiments, the internal wiring harness 443 may be soldered or otherwise permanently affixed to the PCB 210 the second lighting control module 200.

It should be appreciated that the principles of the present disclosure, including the features of the fourth lighting assembly 400 shown on FIG. 10, may be performed using any of the lighting control modules 100, 200, 300 of the present disclosure or another lighting control module that includes features of the lighting control modules of the present disclosure. Any or all of the lighting control modules 100, 200, 300 of the present disclosure may be used for headlights, such as for the headlight assemblies 20a, 20b of FIG. 1 and/or for other vehicular lighting applications.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A lighting control module for a vehicle, comprising:
a housing defining a back surface that is configured to lie flat against an outer surface of an enclosure of a lighting assembly for coupling the lighting control module to the lighting assembly;
an internal connector coupled to the back surface and configured to deliver power to one or more light sources inside the enclosure of the lighting assembly; and
an external connector configured to attach to an external power source outside of the enclosure of the lighting assembly,
wherein the lighting control module is configured to supply power to the one or more light sources inside the enclosure of the lighting assembly using electrical current from the external power source.

2. The lighting control module of claim 1, wherein the external connector is disposed on a side of the housing perpendicular to the back surface.

3. The lighting control module of claim 1, wherein the external connector is disposed on a front side of the housing opposite the back surface.

4. The lighting control module of claim 1, wherein the external connector includes a receptacle for releasable connection to an external wiring harness.

5. The lighting control module of claim 1, wherein the internal connector is configured to releasably attach to a wiring harness inside the enclosure of the lighting assembly.

6. The lighting control module of claim 1, wherein the housing defines an internal space that is in fluid communication with the enclosure of the lighting assembly coupled thereto, and
wherein the lighting control module further includes a membrane of air permeable material arranged to allow pressure equalization between an interior of the enclosure of the lighting assembly and an ambient atmosphere.

7. The lighting control module of claim 1, wherein the housing further includes a cover having fins of a metal material for dissipating heat therefrom.

8. The lighting control module of claim 1, further including a cooling fan attached to an outside surface of the housing and arranged to blow air over the outside surface for dissipating heat therefrom.

9. The lighting control module of claim 1, further including a printed circuit board (PCB) disposed in the housing,
wherein the PCB defines a passage, and
wherein the internal connector extends through the passage in the PCB.

10. A lighting assembly for a vehicle, comprising:
an enclosure;
one or more light sources disposed inside the enclosure; and
a lighting control module disposed on an outer surface of the enclosure,
wherein the lighting control module includes: an internal connector configured to deliver power to one or more light sources inside the enclosure, and an external connector configured to attach to an external power source outside of the enclosure of the lighting assembly.

11. The lighting assembly of claim 10, wherein the internal connector is configured to releasably attach to a wiring harness inside the enclosure of the lighting assembly.

12. The lighting assembly of claim 10, wherein the lighting control module further includes a heat spreader configured to dissipate heat, and
wherein the enclosure defines an air duct configured to direct airflow over the heat spreader of the lighting control module.

13. The lighting assembly of claim 10, further comprising:
an internal cooling block located inside the enclosure and configured to conduct heat from the one or more light sources, and wherein the internal cooling block is in thermal communication with the lighting control module to remove the heat from the enclosure.

14. The lighting assembly of claim 13, further comprising: one or more heat pipes configured to conduct the heat from the internal cooling block and to the lighting control module for removing the heat from the enclosure.

15. The lighting assembly of claim 10, wherein the lighting assembly is operable as a headlight assembly to perform at least one of a low-beam and a high-beam headlight function.

16. A vehicle, comprising:
a lighting assembly including:
an enclosure;
one or more light sources disposed inside the enclosure; and
a lighting control module disposed on an outside surface of the enclosure, wherein the lighting control module includes: an internal connector configured to deliver power to one or more light sources inside the enclosure, and an external connector configured to attach to an external power source outside of the enclosure of the lighting assembly.

17. The vehicle of claim 16, wherein the lighting assembly is disposed on a front face of the vehicle.

18. The vehicle of claim 16, wherein the vehicle is arranged to channel airflow due to motion of the vehicle and across the lighting control module for cooling the lighting control module.

19. The vehicle of claim 18, wherein the vehicle includes a hood and the vehicle is arranged to channel the airflow under the hood and across the lighting control module for cooling the lighting control module while the vehicle is in motion.

20. The vehicle of claim 16, wherein the lighting control module further includes a heat spreader configured to dissipate heat, and
wherein the enclosure defines an air duct configured to direct airflow over the heat spreader of the lighting control module.
